(19) United States
(12) Patent Application Publication
(10) Pub. No.: US 2023/0139435 A1
(43) Pub. Date: May 4, 2023

(54) SYSTEM AND METHOD FOR PROGRESSIVE TRAFFIC INSPECTION AND TREATMENT INA NETWORK

(71) Applicant: VERIZON PATENT AND LICENSING INC., Basking Ridge, NJ (US)

(72) Inventors: Ye HUANG, San Ramon, CA (US); John ANTYPAS, III, Pittsburg, CA (US); Alexander FADEEV, Summit, NJ (US); Michael R. WATERS, Staten Island, NY (US); Pasi UURTAMO, cCumming, GA (US); Miguel A. CARAMES, Long Valley, NJ (US); Thao Phuong HO, Lodi, NJ (US)

(73) Assignee: VERIZON PATENT AND LICENSING INC., Basking Ridge, NJ (US)

(21) Appl. No.: 17/514,866

(22) Filed: Oct. 29, 2021

(51) Int. Cl. H04L 29/06

(52) U.S. Cl. CPC H04L 63/0245; H04L 63/1425; H04L 63/0263

(57) ABSTRACT

Disclosed are systems and methods for an electronic security framework that is configured to detect anomalies, determine (or capture) forensics for those events, and enable mediation to not only address the activity causing the anomaly, but also perform processing steps to prevent the same or similar type of anomaly from occurring again at a later time. In some embodiments, as network requests are received, the disclosed framework can determine the type of activity triggered, whereby the request (e.g., packets) can be subject to a deep inspection, which can trigger the request and/or its associated device being quarantined and/or prevented from operating on the network entirely should a suspect activity that can predicate an anomaly or set of anomalies be detected. The disclosed systems and methods, therefore, provide an advanced, adaptive security backstop for existing networks in order to maintain the integrity of the operations being performed thereon.

### BACKGROUND

In most modern forms for electronic networks, including fixed, wireless and cellular, it is critical to detect and mitigate anomalies. Anomalies, which can take many different forms, can be caused by many different types of activities, faults and/or device and/or user behavior(s).

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example network architecture according to some embodiments of the present disclosure;

FIG. 2 is a block diagram illustrating components of an exemplary system according to some embodiments of the present disclosure;

FIG. 3 illustrates an exemplary network configuration and implementation according to some embodiments of the present disclosure;

FIG. 4 illustrates an exemplary data flow according to some embodiments of the present disclosure;

FIGS. 5A-5C illustrate non-limiting example embodiments according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

The disclosed systems and methods provide a framework that is capable of detecting anomalies, determining (or capturing) forensics for those events, and enabling mediation to not only address the activity causing the anomaly, but also perform processing steps to prevent the same or similar type of anomaly from occurring again at a later time.

Currently, the performance of anomaly detection and mediation can be hindered by time consuming and resource draining processing, as well as costly network configurations and data processing loads. The disclosed systems and methods provide a computationally efficient and accurate security framework that can perform “on-the-spot” processing to quickly and efficiently detect anomalies in real-time (or near-real time). As discussed below, as network requests are received (e.g., devices connected to and operating over a network), the disclosed framework can be applied to determine the type of activity they are triggering. The requests (e.g., packets) can be subject to a deep inspection, which can trigger the request and/or its associated device being quarantined and/or prevented from operating on the network entirely should a suspect activity that can predicate an anomaly or set of anomalies be detected.

In some embodiments, as discussed below, deep inspection can be performed based on a variety of reasons including, but not limited to, security policies, types of data traffic, the acting device(s) identity or location, protocol information, frequency of data traffic, volume of traffic over a period of time, traffic optimization, and the like, or some combination thereof.

According to some embodiments, the disclosed framework executes an advanced approach to analyzing data traffic of devices connected to a network. In some embodiments, as discussed below in more detail, upon connection and transmission of data over the network, data flow records can be generated that represent the activity being performed by the device on the network. As discussed below, the data flow records can include information related to, but not limited to, a source, a destination(s), a protocol type, a domain, and the like. In some embodiments, the framework's processing of these records enables a less computationally intensive (and therefore, cheaper and faster processing of traffic) than traditional deep packet inspection.

Thus, the disclosed systems and methods provide an advanced security backstop for existing networks in order to maintain the integrity of the operations being performed thereon, while adapting to real-world traffic to detect and prevent anomalies from occurring which could hamper the operations of the network and the actions being performed in reliance on the network's stability. The disclosed framework can enable earlier stage identification of threats, and real-time treatment/mitigation of these threats.

For example, as evident from the discussion herein, the disclosed framework's operation can perform denial-of-service (DOS) prevention before the DOS attacks surface on a network, before they are received at particular application servers or even before they reach user devices. As mentioned above, this can result in the data packets (or packet stream) associated with the attack being quarantined. As mentioned below, such quarantining can result in the packets being prevented from reaching their destination, as well as basis for identifying and preventing similar types of attacks in the future from the same or different actor(s).

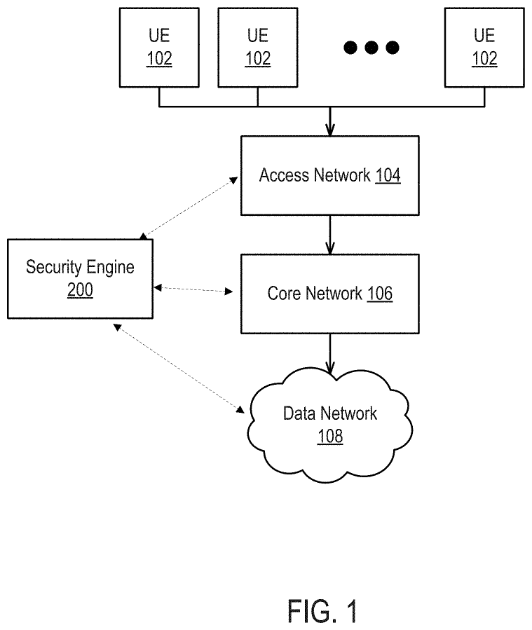

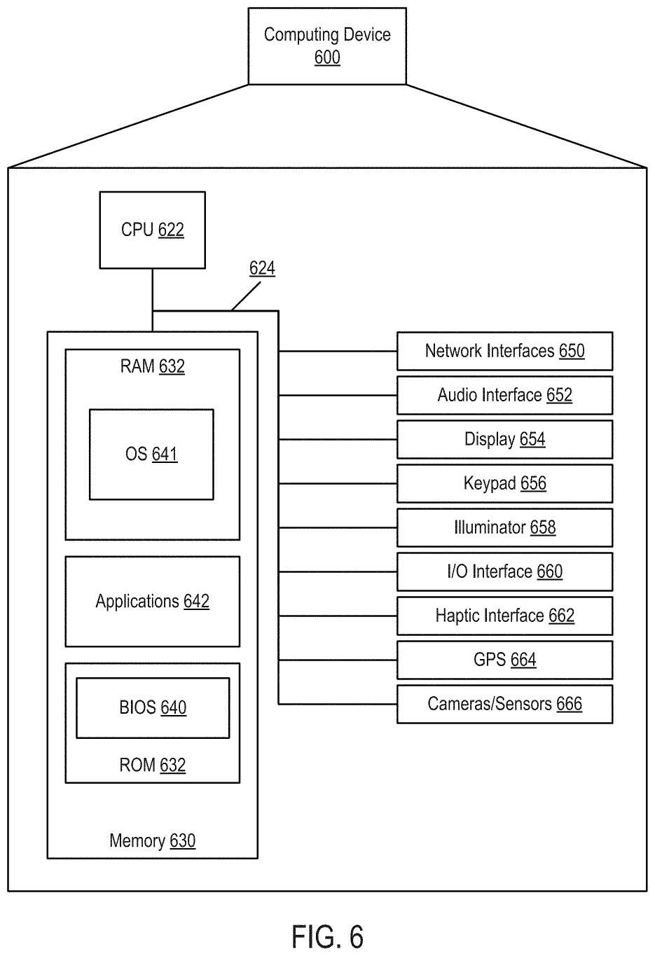

FIG. 1 is a block diagram of an example network architecture according to some embodiments of the present disclosure. In the illustrated embodiment, UE 102 accesses a data network 108 via an access network 104 and a core network 106. In the illustrated embodiment, UE 102 comprises any computing device capable of communicating with the access network 104. As examples, UE 102 may include mobile phones, tablets, laptops, sensors, Internet of Things (IoT) devices, autonomous machines, unmanned aerial vehicles (UAVs), wired devices, wireless handsets, and any other devices equipped with a cellular or wireless or wired transceiver. One non-limiting example of a UE is provided in FIG. 6.

In the illustrated embodiment of FIG. 1, the access network 104 comprises a network allowing network communication with UE 102. In general, the access network 104 includes at least one base station that is communicatively coupled to the core network 106 and coupled to zero or more UEs 102.

In some embodiments, the access network 104 comprises a cellular access network, for example, a fifth-generation (5G) network or a fourth-generation (4G) network. In one embodiment, the access network 104 can comprise a NextGen Radio Access Network (NG-RAN), which can be communicatively coupled to UE 102. In an embodiment, the access network 104 may include a plurality of base stations (e.g., eNodeB (eNB), gNodeB (gNB)) communicatively connected to UE 102 via an air interface. In one embodiment, the air interface comprises a New Radio (NR) air interface. For example, in a 5G network, UE 102 can be communicatively coupled to each other via an X2 interface.

In the illustrated embodiment, the access network 104 provides access to a core network 106 to the UE 102. In the illustrated embodiment, the core network may be owned and/or operated by a network operator (NO) and provides wireless connectivity to UE 102 via access network 104. In the illustrated embodiment, this connectivity may comprise voice and data services.

At a high-level, the core network 106 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 106 and to external network-attached elements in a data network 108 such as, but not limited to, the Internet, a local area network (LAN), a wireless LAN, a wide area network (WAN), a mobile edge computing (MEC) network, a private network, a cellular network, and the like.

In the illustrated embodiment, the access network 104 and the core network 106 may be operated by a NO. However, in some embodiments, the networks (104, 106) may be operated by a private entity, different entities, and the like, and may be closed to public traffic. In these embodiments, the operator of the device can simulate a cellular network, and UE 102 can connect to this network similar to connecting to a national or regional network.

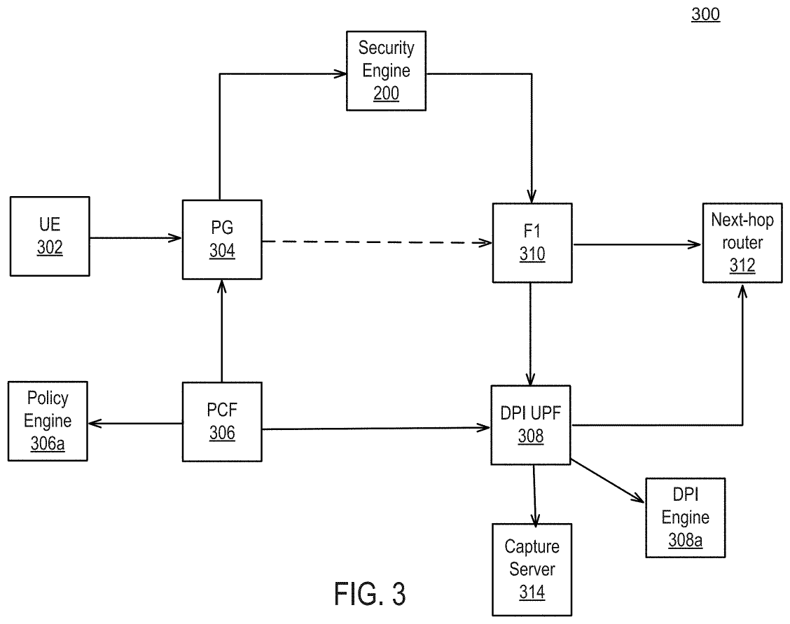

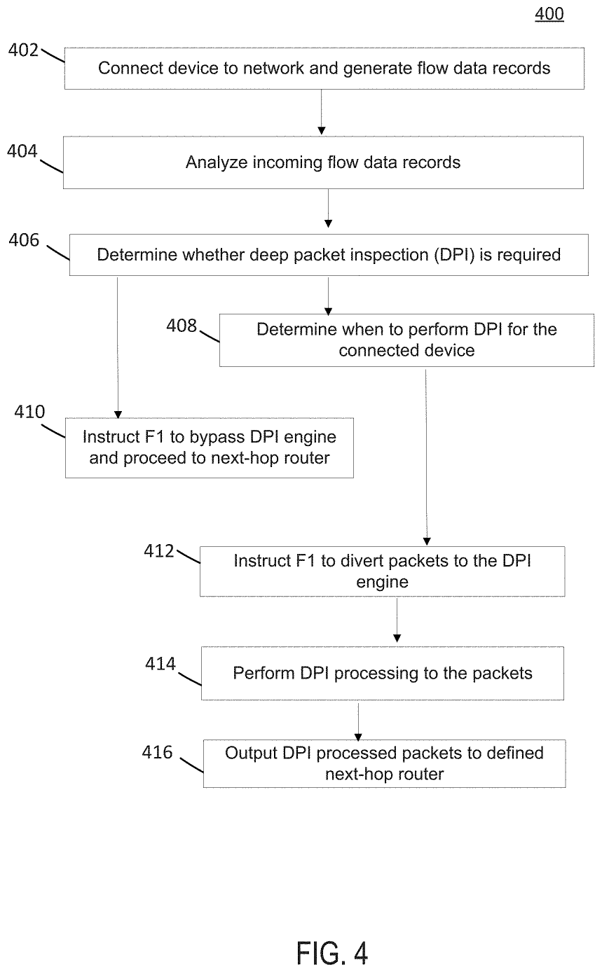

FIG. 1 further includes security engine 200 which can be configured for performing real-time analysis of device's network traffic, as discussed below in relation to FIGS. 3-4. In some embodiments, security engine 200 can be a special purpose machine or processor, and can be hosted by or integrated into functionality associated with access network 104, core network 106 and/or data network 108, or some combination thereof.

In some embodiments, security engine 200 can be hosted by any type of network server, such as, but not limited to, an edge node or server, application server, content server, web server, and the like, or any combination thereof.

In some embodiments, security engine 200 can be embodied as a stand-alone application that executes on a networking server. In some embodiments, the security engine 200 can be hosted, embedded and/or operated by a packet gateway (PG), as illustrated in FIG. 3, and discussed in more detail below. For example, PG can be a packet data network gateway (PGW) in 4G networks; and in 5G networks, a user plane function (UPF), as discussed in more detail below.

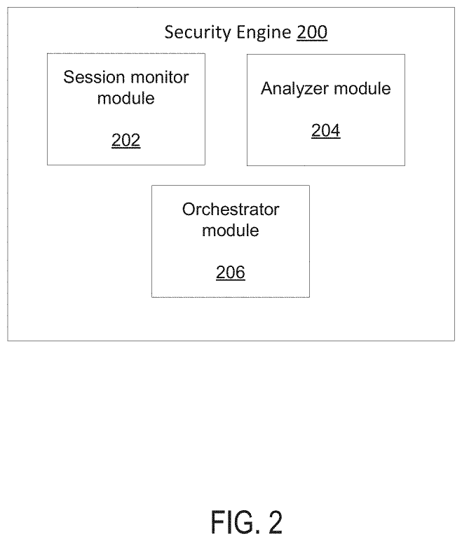

As illustrated in FIG. 2, security engine 200 can include, but is not limited to, session monitor module 202, analyzer module 204 and orchestrator module 206. It should be understood that the engine(s) and modules discussed herein are non-exhaustive, as additional or fewer engines and/or modules (or sub-modules) may be applicable to the embodiments of the systems and methods discussed.

According to some embodiments, security engine 200 ensures the integrity of the network in that suspicious packets, suspicious volumes of packets and/or patterns of particular packets related to network traffic of a device(s) can be identified and flagged for deep inspection to ensure anomalous activity is identified and addressed (e.g., prevented from occurring on the network). More detail of the operations, configurations and functionalities of engine 200 and each of its modules, and their role within embodiments of the present disclosure will be discussed below in relation to FIGS. 3-4.

FIG. 3 provides network environment 300, which includes security engine 200, UE 302, PG 304, Policy Control Function (PCF) 306, security policy engine (“policy engine”) 306a, deep packet inspection (DPI) user plane function (UPF) 308, DPI engine 308a, filtering engine (F1) 310, next-hop router 312 (which, for example, is the intended next destination for a data packet(s) on the network) and capture server 314.

According to some embodiments, network environment 300 can be embodied as a multi-stage configuration that progressively analyzes network traffic from connected UEs (e.g., UE 302), in order to determine i) whether the security of the network and/or other devices operating on the network could be threatened by the traffic, ii) the next-hop router 312 for the traffic, and iii) whether the traffic should be permitted at all (e.g., sent to capture server 314, as discussed below). According to some embodiments, as discussed below, traffic of UEs can be allowed to proceed as “business as usual”, or can be quarantined for DPI and/or have a treatment applied, which can involve, but is not limited to, logging the behavior for future detection of similar activity, blocking, warning destination devices of the activity, warning the initiating device or user to stop or throttle such activity, or drop the initiating device or user from the network, and the like.

Thus, as discussed herein, network environment 300 enables continuous monitoring and inspection of network traffic of the devices connected to the network in order to provide an end-to-end (E2E), real-time solution of orchestrated and tiered security for customer hosted systems.

Network environment 300 represents a connection by UE 302 to a network (e.g., network 104-108), as discussed above in relation to FIG. 1. As mentioned above and discussed below in more detail in relation to Process 400 of FIG. 4, the network connection of UE 302 can produce flow data records related to a packet stream of UE 302, which can include information related to, but not limited to, a source, a destination, a protocol type, a domain, and the like.

UE 302 can connect to PG 304. PG 304 can serve as a logical anchor point for UEs or other edge devices to connect to a network. In some embodiments, for example, PG 304 can operate a router for UE 302 to connection to a 5G network. As mentioned above, PG 304 can be a UPF of a 5G network.

PG 304 can operate in conjunction with F1 310, which is a filtering engine that can divert packets, as discussed below. According to some embodiments, F1 310 can include a Control Function and User Plane components of a network (e.g., a 5G network). For example, in 5G networks, F1 310 can perform a packet stream diversion via a combination of 5G network elements, such as, for example, NEF (network exposure function), SMF (session management function) and UPF.

According to some embodiments, PG 304 can host security engine 200 (as discussed above), whereby the conveyance of information related to data flow records for UE 302 between PG 304 and F1 310 can be handled by security engine 200. As discussed below, security engine 200 can determine and provide instructions for F1 310's processing of traffic of UE 302. As discussed below, in some embodiments, F1 310 can be instructed to pass the packets of traffic to the next-hop router 312 (when no diversion is determined to be required by security engine 200); and in some embodiments, F1 can be instructed to pass the packets of traffic to DPI UPF 308 which hosts DPI engine 308a.

According to some embodiments, DPI engine 308a is configured to perform deep packet inspection on a packet stream. According to some embodiments, DPI engine 308a can be hosted by DPI UPF 308, which can be a dedicated UPF on a network.

As discussed below, the location of the DPI UPF 308 can represent an “investigation” zone within a network where packet streams are diverted for confirmation of their integrity according to applied security policies. As also discussed below, results of the DPI engine 308a executing in connection with DPI UPF 308 can result in packet streams being passed to next-hop router 312, or to capture server 314. The location of the capture server 314 can represent a “quarantine” zone within the network where packets are blocked and/or prevented from reaching their destination, as discussed below.

As discussed below in more detail, DPI engine 308a can perform packet inspection, also referred to as packet sniffing, which can perform a full inspection of packets and the content they represent, including, but not limited to, examination of the header and data the packet is carrying.

According to some embodiments, DPI engine 308a and PG 304 can perform security operations according to policies set by and applied via the policy engine 306a. In some embodiments, for example, policy engine 306a can be hosted by PCF 306. According to some embodiments, policy engine 306a can be configured as a 3GPP compliant policy controller. In some embodiments, policy engine 306a can be configured to inform PG 304 and F1 310 as to how packets are to be processed and/or diverted.

FIG. 4 provides Process 400 which details non-limiting example embodiments of the processing of a packet stream of UE 302 when connected to the network of network environment 300, as discussed above in relation to FIG. 3. The steps of Process 400 will be discussed with reference to the components of network environment 300 of FIG. 3, as mentioned above.

According to some embodiments, Step 402 of Process 400 can be performed by session monitor module 202 of security engine 200; Steps 404-408 can be performed by analyzer module 204; and Steps 410-416 are performed by orchestrator module 206.

Process 400 begins with Step 402 where a UE 302 (e.g. a user device, such as for example, a smart phone) connects to a network. As discussed above, UE 302 connects to a PG 304 of the network. As a result of the UE 302's connection to PG 304, flow data records are generated.

According to some embodiments, PG 304 receives policy instructions (e.g., policy directives) from policy engine 306a which guide PG 304 as to how to generate flow data records for UE 302. The policy instructions also provide criteria for managing, controlling and inspecting data traffic of UE 302 on the network (e.g., data packets and flow data records), as discussed below. In some embodiments, based on the received instructions, PG 304 can call or execute security engine 200 to analyze the generated flow data records to determine how they are to be processed, as discussed below.

According to some embodiments, flow data records can be specific to a type of network protocol used. Flow data records can include (or convey), as mentioned above, a source (e.g., addresses, names and/or channels of the source), destinations (e.g., addresses, names and/or channels of each destination), the protocol in use, a number of bytes/octets sent and received, and a data and time of their transmission and reception, and the like. In some embodiments, the protocol in use can be, but is not limited to, TCP/IP (Transmission Control Protocol/Internet Protocol), and the flow data records can include TCP/IP information, which can include, but is not limited to, source IP address, source IP port range, source fully-qualified domain name, destination IP address, destination IP port range, destination fully-qualified domain name, bytes/octets sent/received, date and time of flow start, date and time of flow end, network identifier elements (e.g., access point name (APN), international mobile subscriber entity (IMSI), international mobile equipment identity (IMEI), universal integrated circuit card (UICC), slice ID, and the like).

In Step 404, the flow data records are analyzed. In some embodiments, the analysis is performed based on policy directives received from the policy engine 306a. In some embodiments, the policy directives can indicate a criteria related to a type, value, pattern and/or identity of information within flow data records that dictates whether further analysis is required.

In Step 406, based on the analysis by security engine 200 in Step 404, a determination is made regarding whether DPI is required. This determination is based on whether the criteria of the policy directives are satisfied or not. For example, if the flow data records are associated with a particular pattern of a packet stream that the policy engine 306a has indicated is typically associated with anomalous (or malicious) activity, then the analysis by security engine 200 can result in a determination that further analysis via DPI may be required. In another non-limiting example, if the flow data records include information that corresponds to a DOS attack, then DPI is required.

In some embodiments, the determination in Step 406 can provide options for security engine 200 to select, which can be based on the type of anomaly, a frequency of the anomaly, a frequency that the anomaly or type of anomaly has been triggered via activity of a particular device, and the like. In some embodiments, the options can be provided and/or automatically selected based on the policy directives from policy engine 306a. In some embodiments, the options can involve, but are not limited to, choosing to automatically divert (or not divert) packets (e.g., current or incoming packets), asking a subscriber whether they wish to divert packets, asking a subscriber when to divert packets, and/or forcing UE 302 to drop its session and reconnect (e.g., re-perform Step 402).

In some embodiments, when security engine 200 determines that the flow data records do not trigger an alert (e.g., do not violate a criteria of the applied policy directives), as in Step 406, Process 400 can proceed from Step 406 to Step 410. In Step 410, F1 310 is instructed to pass the packet stream of UE 302 to the next-hop router 312 without performing DPI (e.g., bypass further analysis by DPI engine 308a). This represents the “business as usual” approach to handling network traffic where after analysis by security engine 200, the operations of UE 302 over the network are determined to be in compliance with existing security measures dictated by policy engine 306a.

In some embodiments, Process 400 can proceed from Step 406 to Step 408 when a determination is made that DPI is required. In Step 408, a determination is made as to when to perform DPI (e.g., when to route the packets generated by UE 302's connection with PG 304 to the DPI engine 308a). In some embodiments, the determination of Step 408 can be based on a type of anomaly detected in Steps 404-406. In some embodiments, the determination in Step 408 can be based on a selection option(s), as discussed above.

In some embodiments, Step 408's determination can correspond to which criteria within the policy directives from policy engine 306a was triggered that caused DPI to be requested. For example, if a DOS attack is detected, then DPI can be determined to be performed on the flow data records and their associated packets in real-time (e.g., as they are received and identified as pertaining to a DOS attack). For less critical anomalies, such as, for example, higher than normal volumes of packets from UE 302, DPI can be determined to be performed for subsequently incoming packets so as to monitor the incoming volume to check whether it increases, maintains its current level (e.g., within a predetermined range), or subsides.

Process 400 can proceed from Step 408 to Step 412, where F1 310 can be instructed to divert packets to DPI engine 308a for further analysis. Thus, rather than the next-hop router 312 receiving the packets from UE 302 (as in Step 410), the packets can be routed via the filtering engine of F1 310 orchestrating network control elements to switch the packet destination to DPI engine 308a. As mentioned above, the subsequent processing now embarks on the “investigation” of the packets to determine whether they are in compliance with policies the DPI engine 308a (via the DPI UPF 308) are enforcing.

In Step 414, DPI engine 308a performs DPI processing of the diverted packets of UE 302. In some embodiments, DPI engine 308a is provided policy data by policy engine 306a which controls how the deep packet inspection is performed on the diverted packets. In some embodiments, as mentioned above, by DPI engine 308a further analyzing the header and contents of the data packets, which are based on the criteria provided by policy engine 306a, DPI engine 308a can provide a more effective mechanism for executing network packet filtering and identifying otherwise hidden threats within a data stream, such as attempts at data exfiltration, violations of content policies, malware and the like.

According to some embodiments, the processing of DPI engine 308a in Step 414 enables the network to determine how to handle the data packets and connection of UE 302.

In some embodiments, as mentioned above, UE 302 and/or its associated packets can be quarantined when it is determined that they represent activity that is not in compliance with the security policies being enforced by DPI engine 308a. In some embodiments, for example, the packets can be considered “quarantined” and sent to a specific server (e.g., a capture server 314) for the storage and quarantining of traffic. In some embodiments, the capture server 314 can compile a log of information related to quarantined traffic which can be used to identify similar types of threats in the future. In some embodiments, this can be provided to the policy engine 306a or made available to the policy engine 306a for updating policy directives that are applied by security engine 200 and DPI engine 308a.

In some embodiments, quarantining of UE 302's data traffic can result in PG 304 disconnecting UE 302 from the network. In some embodiments, this may enable UE 302 to request reconnection; however, in some embodiments, PG 304 may block reconnection for at least a predetermined period of time. In some embodiments, a subscriber associated with disconnected UE 302 may be blocked for a predetermined period of time.

In some embodiments, rather than sending the packets to the capture server 314, they can be sent back to PG 304 for re-analysis via the steps discussed above (e.g., Steps 404-406).

In some embodiments, upon confirmation that UE 302 is operating in compliance with the security policies enforced by DPI engine 308a, DPI engine 308a (via, for example, DPI UPF 308) can proceed in passing them to a next-hop router 312.

In Step 416, the data output from the DPI processing of Step 414 can be sent to a next-hop router 312. In some embodiments, Step 416 can involve sending approved packets, or indications that packets are being held or blocked from being passed to the router, as discussed above. In some embodiments, indications being sent to the next-hop router 312 for quarantined data traffic can include information related to warnings that can alert the destination device of detected threats.

Thus, as a result of Process 400, an adaptive multi-stage security framework can be applied to network functions in order to maintain the integrity of the operations being performed on the network by the devices connected to the network and the services being hosted on the network. By generating and analyzing flow data records on a connected device basis, implementation of the framework can reduce the amount of resources required to secure a network. That is, by performing on-demand DPI, rather than constant DPI for all packets or packet-offloading for offline analysis, networks can operate more efficiently be dedicating their resources to network processing rather than advanced security features since the advanced security features can be called for specific occurrences without bottling up normal network traffic.

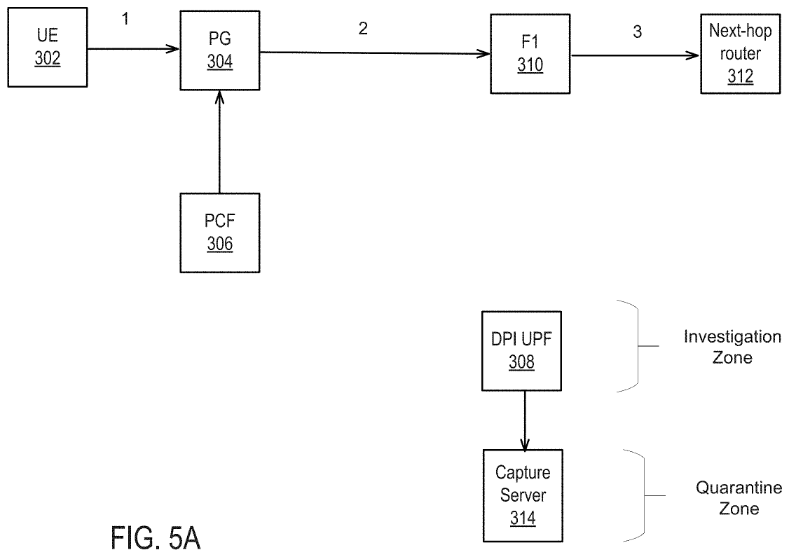

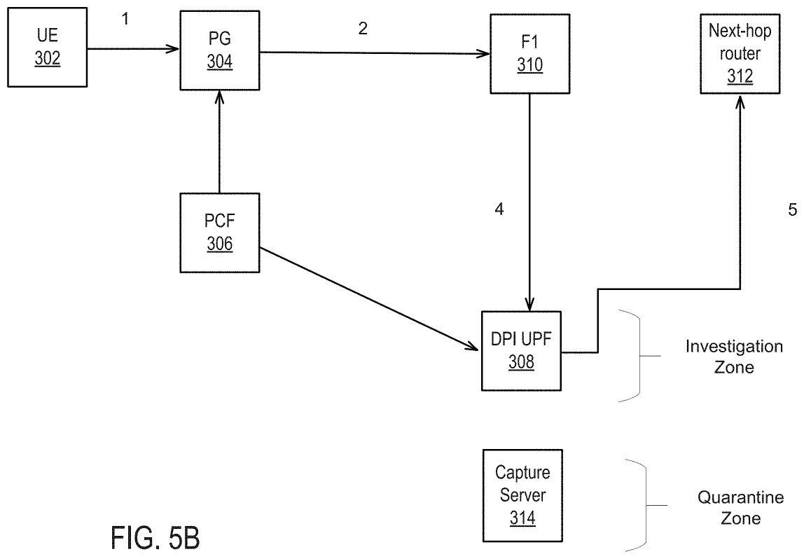

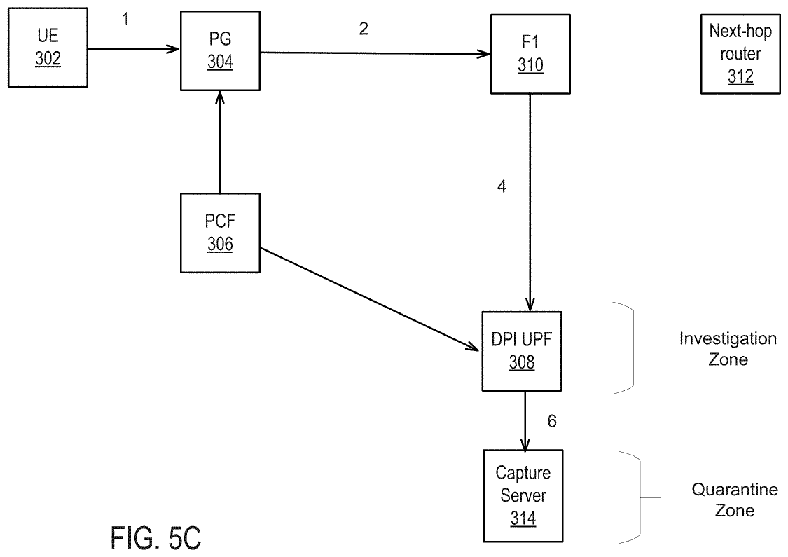

FIGS. 5A-5C provide non-limiting example embodiments of the implementation of the components of network environment 300 from FIG. 3 according to embodiments of the processing of Process 400 of FIG. 4. According to some embodiments, FIGS. 5A-5C illustrate the processing discussed above in relation to FIGS. 3-4 i) where data packets are treated as “business as usual” and proceed to the next hop router 312 (i.e., FIG. 5A); ii) where data packets are diverted to the DPI UPF 308 for deep inspection, then allowed to proceed to the next-hop router 312 (i.e., FIG. 5B); and iii) where data packets are diverted to the DPI UPF 308, and then quarantined by diverting them to the capture server 314 (i.e., FIG. 5C).

In FIGS. 5A-5C, according to some embodiments, UE 302 connects to PG 304 (Step 1). PG 304 receives the policy instructions from PCF 306, as discussed above. In some embodiments, PCF 306 can provide PG 304 these instructions prior to UE 302 connecting or upon UE 302 connecting, or both.

As discussed above, PG 304 can perform an initial analysis of the data packets via the data flow records generation and analysis, as discussed above, which can be performed via the implementation and execution by security engine 200. As represented in Step 2, this enables F1 310 to receive instructions to either enable the data packets to flow to next-hop router 312 or divert them to DPI UPF 308 (e.g., the quarantine zone of the network for further inspection, as discussed above).

In the embodiments represented by FIG. 5A, F1 receives instructions from PG 304 (via security engine 200 in Step 2) to allow the data packets to pass to next hop router 312 (Step 3). Thus, they are considered to comply with the policy instructions PG 304 is enforcing.

In the embodiments represented by FIG. 5B, when F1 receives instructions in Step 2 to divert the data packets, F1 310 passes the data packets to DPI UPF 308 (Step 4). Here, as discussed above, DPI UPF 308 (via DPI engine 308a) performs deep packet inspection. When it is determined that the packets are in compliance with inspection policies provided by PCF 306, as discussed above, DPI UPF 308 can pass the data packets to next hop router 312 (Step 5).

In the embodiments represented by FIG. 5C, when DPI UPF 308 (via DPI engine 308a) determines that the data packets are not in compliance with the policies provided by PCF 306, then the data packets are diverted to the capture server 314 for quarantine (Step 6), as discussed above.

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a central processing unit (CPU) 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
receiving, by a device on a network, a packet stream from a user device;
generating, by the device, flow data records based on the packet stream, the flow data records comprising information related to activity of the user device on the network;
analyzing, by the device, the flow data records based on policy information, the policy information indicating a criteria for controlling data traffic on the network; and
determining, by the device, based on the policy information based analysis, whether deep inspection is required for the packet stream of the user device, the determination further comprising:
when the determination indicates that deep packet inspection is not required, enabling the packet stream of the user device to proceed to a next-hop router on the network, and
when the determination indicates that deep packet inspection is required, diverting the packet stream for the deep packet inspection prior to the packet stream being routed to the next-hop router.

2. The method of claim 1, further comprising:
receiving, by the device, policy data for performing the deep packet inspection; and
performing the deep packet inspection based on the policy data.

3. The method of claim 2, further comprising:
analyzing a header and contents of each packet in the data stream based on the policy data, wherein the deep packet inspection is based on the header and packet content analysis.

4. The method of claim 1, further comprising:
determining, by the device, based at least on the policy information based analysis, a time to perform the deep packet inspection; and
performing the deep packet inspection at the determined time.

5. The method of claim 4, wherein the time determination is based on a type of anomaly identified during the policy information based analysis.

6. The method of claim 1, further comprising:
routing, by the device, information related to the packet stream to the next-hop router based on the deep packet inspection, wherein the information routed is based on a result of the deep packet stream.

7. The method of claim 1, further comprising:
receiving, by the device, the set of policy information, wherein the set of policy information is based on a type of protocol implemented by the network.

8. The method of claim 1, wherein the criteria of the policy information relates to at least one of a type, value, pattern and identity of activity on the network.

9. The method of claim 1, wherein the flow data records comprise information related to at least one of a source, a destination, protocol in use on the network, protocol information, a number of bytes/octets sent and received, a data and time of packet transmission and reception.

10. A device comprising:
a processor configured to:
receive a packet stream from a user device;
generate flow data records based on the packet stream, the flow data records comprising information related to activity of the user device on a network;
analyze the flow data records based on policy information, the policy information indicating a criteria for controlling data traffic on the network; and
determine, based on the policy information based analysis, whether deep inspection is required for the packet stream of the user device, wherein the processor is further configured to:
when the determination indicates that deep packet inspection is not required, enable the packet stream of the user device to proceed to a next-hop router on the network, and
when the determination indicates that deep packet inspection is required, divert the packet stream for the deep packet inspection prior to the packet stream being routed to the next-hop router.

11. The device of claim 10, wherein the processor is further configured to:
receive policy data for performing the deep packet inspection; and
perform the deep packet inspection based on the policy data.

12. The device of claim 11, wherein the processor is further configured to:
analyze a header and contents of each packet in the data stream based on the policy data, wherein the deep packet inspection is based on the header and packet content analysis.

13. The device of claim 10, wherein the processor is further configured to:
determine, based at least on the policy information based analysis, a time to perform the deep packet inspection, wherein the time determination is based on a type of anomaly identified during the policy information based analysis; and
perform the deep packet inspection at the determined time.

14. The device of claim 10, wherein the processor is further configured to:
route information related to the packet stream to the next-hop router based on the deep packet inspection, wherein the information routed is based on a result of the deep packet stream.

15. The device of claim 10, wherein the processor is further configured to:
receive the set of policy information, wherein the set of policy information is based on a type of protocol implemented by the network, wherein the criteria of the policy information relates to at least one of a type, value, pattern and identity of activity on the network.

16. A non-transitory computer-readable medium tangibly encoded with instructions, that when executed by a processor of a device, perform a method comprising:
receiving, by the device on a network, a packet stream from a user device;
generating, by the device, flow data records based on the packet stream, the flow data records comprising information related to activity of the user device on the network;
analyzing, by the device, the flow data records based on policy information, the policy information indicating a criteria for controlling data traffic on the network; and
determining, by the device, based on the policy information based analysis, whether deep inspection is required for the packet stream of the user device, the determination further comprising:
when the determination indicates that deep packet inspection is not required, enabling the packet stream of the user device to proceed to a next-hop router on the network, and
when the determination indicates that deep packet inspection is required, diverting the packet stream for the deep packet inspection prior to the packet stream being routed to the next-hop router.

17. The non-transitory computer-readable medium of claim 16, further comprising:
receiving policy data for performing the deep packet inspection; and
performing the deep packet inspection based on the policy data by analyzing a header and contents of each packet in the data stream based on the policy data.

18. The non-transitory computer-readable medium of claim 16, further comprising:
determining, by the device, a time to perform the deep packet inspection, wherein the time determination is based on a type of anomaly identified during the policy information based analysis; and
performing the deep packet inspection at the determined time.

19. The non-transitory computer-readable medium of claim 16, further comprising:
routing, by the device, information related to the packet stream to the next-hop router based on the deep packet inspection, wherein the information routed is based on a result of the deep packet stream.

20. The non-transitory computer-readable medium of claim 16, further comprising:
receiving, by the device from a policy engine on the network, the set of policy information, wherein the set of policy information is based on a type of protocol implemented by the network, wherein the criteria of the policy information relates to at least one of a type, value, pattern and identity of activity on the network.
